(19) United States
(12) Patent Application Publication
(10) Pub. No.: US 2009/0267867 A1
(43) Pub. Date: Oct. 29, 2009

(54) DISPLAY EXTENSION OF PORTABLE DEVICES

(75) Inventor: Patrick S. Gonia, Maplewood, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/111,100

(22) Filed: Apr. 28, 2008

(51) Int. Cl. G09G 5/00; G09G 5/08

(52) U.S. Cl. 345/1.1; 345/157

(57) ABSTRACT

Apparatus, systems, and methods may operate to establish a temporary short range wireless link between at least one portable device and a public display having public content displayed on a first portion of the public display, provide a display area for the portable device in a second portion of the public display, receive portable device content from the portable device over the link at the public display, and display, to a user of the portable device, at least some of the portable device content on the second portion of the public display in substantially real time. Additional apparatus, systems, and methods are disclosed.

### BACKGROUND

Portable electronic devices, including hand-held devices (e.g., personal digital assistants (PDAs) and cellular telephones), by their very nature have a limited display capability. The ubiquitous availability of high-speed network connectivity, combined with greater use of the Internet worldwide, has increased consumer demand for portable device displays having better-resolution and larger size.

### BRIEF DESCRIPTION OF THE DRAWINGS

FIG. 1 illustrates extending the display of portable device content to an area of a public display according to various embodiments of the invention.

FIG. 2 is a block diagram of apparatus and systems according to various embodiments of the invention.

FIGS. 3 and 4 include a flow diagram illustrating several methods according to various embodiments of the invention.

FIG. 5 is a block diagram of an apparatus including a machine-readable medium according to various embodiments of the invention.

### DETAILED DESCRIPTION

Wherever people are captive, such as in waiting areas for subways, trains, planes, and buses, electronic billboards are beginning to make their appearance, serving as virtual “wallpaper” and filling the field of view with advertisements and other information intended for communication to the captive audience. Indeed, electronic displays controlled/owned by advertisers are eventually expected to be as ubiquitous as paper-based displays.

To respond to the consumer demand for better display capability described above, the inventor has discovered that the resources of these electronic billboards or “e-displays” can be leveraged to extend the display capability of portable handheld electronic devices. In most embodiments, a portable device, such as a cellular telephone under the control of its user, can operate to dynamically extend its display onto larger public electronic displays using a short range wireless communication link.

For the purposes of this document, the following terms are defined:

To “extend” the display of portable device content to a public display means that a portion of the public display is enabled to render content that is dynamically provided by the portable device. The same or different views of portable device content may be shown on the display of the portable device and the public display at substantially the same time. For example, a user might view a movie stored in the portable device on the portion of the public device display, and surf the Internet (accessed by the portable device) on the portable device display, or vice versa. Another example might include viewing a single large spreadsheet, with one portion on the portable device display and another portion on the public display. The public display may be at higher resolution or use larger fonts such that it may be easier to read the portable device content that is extended.

“Portable device content” is selected for extension to a public display first by a processor in the portable device, and subsequently by a processor in the public display. Portable device content is communicated only from portable devices, and is not initially selected for presentation by the processor in the public display. Portable device content can be wirelessly communicated to the public display, so that no intermediate devices are used to relay the portable device content from the portable device to the public display.

A “portable device” comprises an electronic device that is portable, with logic that can operate to establish one or more short range wireless communications links to initiate and maintain the extension of portable device content for presentation as extended content on one or more public displays. Portable devices may also have the capability to establish a long range wireless link to communicate other information (e.g., a cellular telephone communicating with a cellular tower). Portable devices may therefore comprise laptop computers, tablet computers, palmtop computers, personal digital assistants (PDAs), media players, and cellular telephones, among others.

A “public display” is an electronic display with static or dynamically changing content that presents information for consumption by those individuals who may be within visual range. Typical applications of public displays include electronic billboards or other electronic displays (“e-displays”) that are operated in public spaces to present advertising and other information as public content. The presentation of public content on the public display is controlled solely by a processor in the public display.

“Public content” refers to the static or dynamic content of information presented on the public display that is determined by the owner of the display, typically for purposes of advertising. Public content can be received or updated at the public display using a wired or wireless network coupled to the public display.

A portion of a public display or a “portable device window” may be made accessible to a portable device that is local to the public display. In return for making a portion of the public display available to the portable device, the public display owner may obtain some financial benefit. Multiple portable devices may be allocated multiple portable device windows on the same public display.

“Real time” with respect to the extended display of portable device content on a public display means that the delay between sending the portable device content to the public display and the visible presentation by the public display of the portable device content (as extended content) is less than about two seconds.

A “short range wireless link” means a communications link using wireless technology that enables wireless communication between the portable device and the public display with range of at least a meter. Such links may be created using infra-red, Wi-Fi, or Bluetooth™ technology, for example.

The term “transceiver” (e.g., a communications device including a transmitter and a receiver) may be used in place of either “transmitter” or “receiver” throughout this document. Thus, anywhere the term transceiver is used, “transmitter” and/or “receiver” may be substituted, depending on the functions that are used.

“Wide area wireless link” means a communication link using wireless technology that enables wireless communication over several kilometers of range, such as that used to reach the nearest cellular telephony tower. Examples include various cellular and point-to-point wireless technologies, such as WIMAX (Worldwide Interoperability for Microwave Access), UMTS (Universal Mobile Telecommunications System), GPRS (General Packet Radio Service), CDMA (Code Division Multiple Access), GSM (Global System Mobile), CDPD (Cellular Digital Packet Data), Mobitex, HSDPA (High-Speed Downlink Packet Access), 3G (Third-Generation Mobile Phone Standards), LMDS (Local Multipoint Distribution Service), and Wi-Fi (WLAN products that are based on the IEEE 802.11 standards).

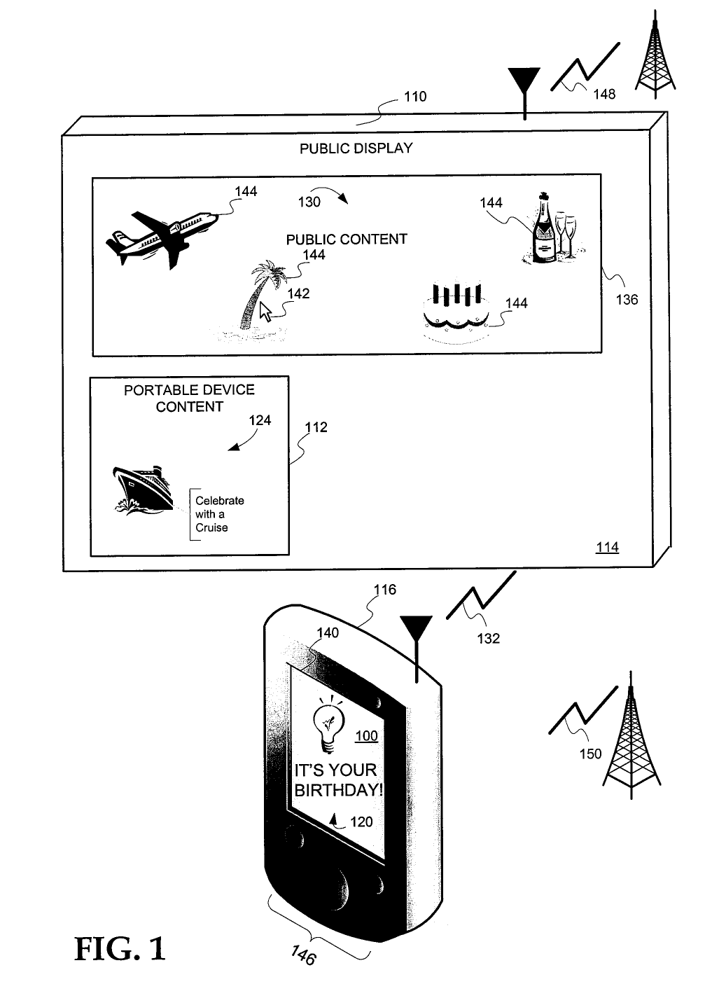

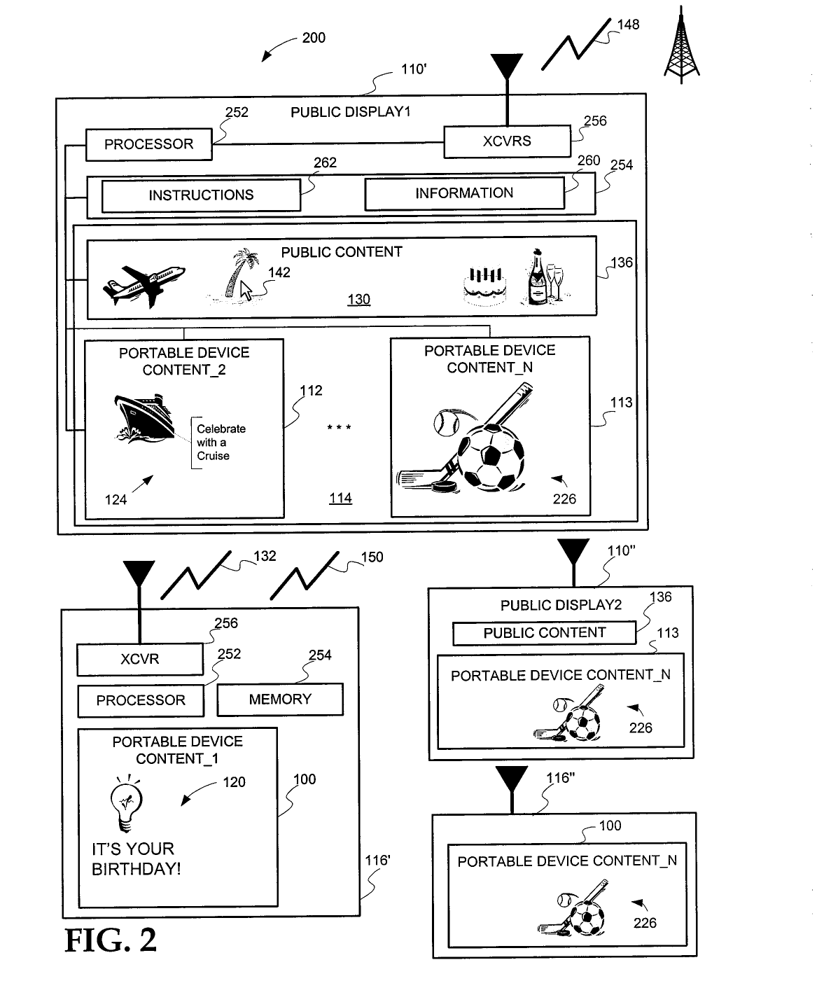

FIG. 1 illustrates extending the display of portable device content 124 to a display area 114 of a public display 110 according to various embodiments of the invention. As shown in the figure, the portable device content is divided between the portable device content 120 displayed on the display 100 of the portable device 116 and the portable device content 124 displayed on a portion 112 of the display area 114 of the public display 110. It should be noted that the portable device 116 can operate so that the portable device content 120 displayed on the portable device display 100 is different than the portable device content 124 displayed on the public display 110, as shown in FIG. 1. The portable device 116 can also operate so that the portable device content 120 displayed on the portable device display 100 is the same as the portable device content 124 displayed on the public display (see, for example, portable device content 226 in FIG. 2).

Owners of public displays 110 may be willing to have a portion 112 of the display area 114 controlled by a portable device 116 in exchange for compensation. Compensation may be provided in the form of rent paid by the portable device owner, advertising revenue paid by advertisements appearing as public content that may be related to the portable device content, and in other ways. Indeed, additional advertising revenue may be received based on additional viewers attracted by the offer of an option to display portable device content supplied by users of portable devices 116. The display of portable device content 124 may, by an acknowledged request, appear as extended content 124 on the public display 110 in a picture-in-picture (PIP) format, or perhaps be switched over time, alternating between the public content 130 controlled solely by the public display owner, and the portable device content 124, controlled by the owner of the portable device 116. The portion 112 of the public display area 114 used to display portable device content 124 may be completely separated from the portion 136 of the public display area 114 used to display the public content 130, as shown in FIG. 1.

Rapid automatic binding can be used for quick setup/teardown of a short range wireless link 132 between the portable device 116 and the public display 110. Thus, a portable device 116 may receive content via a wireless wide-area wireless link 150, and the portable device may select a subset of the content, the “portable device content” 124, to be forwarded to the public display 110 using a short range wireless link 132 (e.g., Wi-Fi or Bluetooth™ communication). In this way, the portable device 116 operates in conjunction with the larger public display 110 to achieve increased information content flow that benefits the user of the portable device 116. Readers that desire to know more about implementing the Wi-Fi and Bluetooth™ standards are encouraged to consult “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and the “Bluetooth™ Specification Version 2.1+EDR”, Vol. 0, Bluetooth SIG, Inc., July 2007, and related versions.

In some embodiments, the portable device user is permitted to extend the display of portable device content 124 to a nearby public display 110 without additional consideration; perhaps the service is offered freely to portable device users in return for advertising revenue paid by the sponsor of the public content 130 to the owner of the public display 110. Portable device users may be serviced on a first come, first served basis—each with a timeout. In other embodiments, the portable device user pays a per-use rental fee, or a periodic (e.g., monthly) service charge for the privilege of extending the display of portable device content 124 to an area 112 of the public display 110 whenever desired, or for some time-limited amount per each rental period. Combinations of these approaches are also possible.

Thus, various embodiments may be realized to permit portable device owners to read a book, watch a video or television, browse the internet etc. while they spend time near a public display 110. Embodiments of the invention permit the public display area 114 to be used not only for the normal public purpose of displaying public content 130, but also for the occasional allocation of a display window or portion 112 for use by a local wireless portable device 116. As a matter of contrast with the typical operation of a public display, in most embodiments of the invention, the selection of portable device content 124 presented by the larger display 110 is controlled by the portable device user, additional revenue for the owner of the public display is normally generated, and the source of the extended portable device content 124 (e.g., portable device 116) can change dynamically.

In some embodiments, the size of the portion 112 of the public display area 114 devoted to the display of portable device content 124 can be controlled by the owner of the public display 110 and influenced within limits by the user of the portable device 116. That is, the display of the portable device content 124 is controlled in part by communication received at the public display 110 over the link 132. In addition, the time available for extension of the portable device content 124 may be controlled by the public display 110 owner and influenced within limits by the user of the portable device 116. In this way, the owner of the public display 110 may attract customers to view advertising on the public display 110 in return for permitting a portion 112 of the public display 110 display area 114 to be controlled by the portable device 116 user, generating advertising revenue for the owner of the public display 110 via the additional customer attraction. In some embodiments, the size and/or timing of extended content 124 display is controlled entirely by the owner of the public display 110. In others, control is shared between the portable device user and the public display owner.

Advertising revenue may be based on updated (more valuable) advertising content displayed as part of the public content 130 where the update is based on the portable device content 124 selected for extension. A higher value may be obtained in some cases because it may be deduced that a viewer having interests reflected by the type of content 124 selected is viewing the public display 110 at a particular time.

In some embodiments, the portable device user is permitted to interact with the public display 110 to select more information regarding a particular item 144 presented as part of public content 130, perhaps by using a cursor 142 (e.g., moved by controls 146 on the portable device 116) that may be able to roam over a portion or the entire display area 114 of the public display 110 so that items 144 of interest may be selected. Alternatively, the cursor 142, under the control of the portable device 116, may be prevented from appearing on portions 113 of the display area 114 used for the extended display of another portable device. Many other types of interaction are possible.

For example, a book may be displayed as part of the extended content 124, and the portable device controls 146 used to turn the pages of the book. Similarly, a movie or video clip may be viewed as part of the extended content 124, and the controls 146 used to play, pause, fast-forward, etc. the sequence of movie frames. A user of the portable device 116 may also use the portion 112 of the public display area 114 to browse the Internet, where Internet content may be drawn from the wide area wireless link 150.

A second communication link 148 (e.g., a wide area wireless link) may be used to control public display operations, and/or update the public content 130 or other information in the memory of the public display 110.

Many other embodiments may be realized. For example, the owner of the public display 110 may permit downloading content to the portable device 116 via the link 132. The public display 110, or a server coupled to the public display 110 may be programmed to reject portable device content 124 that is found to be objectionable, perhaps based on words or images and using filtering algorithms well-known to those of ordinary skill in the art. The extended display of portable device content 124 may also be rejected based on complaints received at the public display 110, perhaps via other links 132 to other portable devices or received at a server coupled to the display 110. If the portable device content 124 from a particular portable device 116 has been rejected, the extension of further portable device content 124 from that same device 116 may continue to be rejected for at least a selected time-out period.

The display of the public content 130 may be affected by many parameters, including the time of day, a selection via the cursor 142 controlled by a portable device 116 accessing the public display 110, centralized management of the public display 110, the current geo-location of the public display 110, the number of portable device users accessing the public display 110 at the same time, the proximity of a point of sale (POS) terminal to the public display 110, the timing and/or size of the portion 112 of the public display area 114 used for extended content 124 display, and/or the history of the portable device content 124 selected for extended display.

In some embodiments, the public display 110 may itself serve as a POS terminal—permitting the selection of items 144 for purchase, where consideration is received in the form of credit card information associated with the user of the portable device 116, etc.

The public display 110 may operate to gather data regarding display activity of any portable device 116 that engages in extended display operation, where the data is stored and/or reported back to the owner of the public display 110. Thus, many additional embodiments may be realized.

For example, FIG. 2 is a block diagram of apparatus 200 and systems according to various embodiments of the invention. For example, an apparatus 200 according to some embodiments comprises a public display 110′ to display a combination of public content 130 selected by logic (e.g., processor 252 and/or memory 254) in the public display 110′, and portable device content 124, 226 provided by one or more portable devices 116′, 116″.

The apparatus 200 may include wireless transceivers 256, including a short range wireless transceiver to receive a short range request over the link 132 from at least one of the devices 116 to extend corresponding portable device content 124 to a portion 112 of the public display area 114, and to display at least some of the portable device content 124 on the portion 112 of the public display area 114 in substantially real time. The transceivers 256 can also include a wide area transceiver to communicate using the optional link 148. It should be noted that while various elements (e.g., the transceivers 256) are shown as forming part of the public display 110′ in the figure, such elements may also exist as separate components in operational communication with the public display 110′.

A single portable device 116′ may access multiple public displays 110′, 110″, and multiple portable devices 116′, 116″ may access a single public display 110′ (that allocates corresponding multiple portions 112, 113 to the display of extended content 124, 226. Here, one of the portable devices 116′ is operating to extend the portable device content 124 to the public display 110′ that is different than the portable device content 120 displayed on the display 100 of the portable device 116′. As a matter of contrast, another portable device 116″ is operating to extend the portable device content 226 to each of two public displays 110′, 110″ that is the same as the portable device content 226 displayed on the display 100 of the portable device 116″, although it may be displayed at a different resolution.

In some embodiments, the apparatus 200 includes a storage device 254 (e.g., memory, such as random access memory, FLASH memory, a disk drive, and other memory, including combinations of memory types) to couple to the wireless transceiver 256 and to record at least some information 260 associated with the portable device content 124 to be transmitted after the link 132 is established. For example, the information 260 might include the identity of the owner of the portable device 116′, a signature associated with the portable device 116′, a URL associated with the portable device content 124, other characteristics of the portable device content 124, the date and time when an extension request was made by the portable device 116′, the date/time when the link 132 was established, etc. This information 260 may be gathered in real time, or gathered periodically for direct transmission to the owner of the display 110′. This information 260 may also be used to formulate a report for subsequent transmission to the owner of the display 110′ via the link 148. In this way, the storage device 254 may be used to store a history of portable device display extension activity that can later be transmitted to the owner of the public display 110′ and formatted into a report that tracks usage of the public display 110′. Of course, as noted above, current usage activity and/or usage history related to the portable device content 124 may be used to select specific public content 130 for display in real time. The storage device 254 may also be utilized to record advertising revenue information associated with the portable device content 124.

The processor 252 may be used to access and execute instructions 262 stored in the storage device 254. Thus, when the prior elements and embodiments are considered, it can be seen that the apparatus 200 may include a processor 252 to couple to the transceiver 256, wherein the processor 252 is to execute instructions 262 to select at least a portion of the public content 130 based on the geo-location of the public display 110′, the portable device content 124, 226 and/or a selection (e.g., perhaps made using a cursor 142 controlled by the portable device 116′) displayed on the public display area 114 and received from the device 116′. In this way, selection of the public content 130 can be automated, and/or partially influenced by various circumstances, including selections received from the device 116′.

Any of the components previously described can be implemented in a number of ways, including simulation via software. Thus, the displays 110, 110′, 110″; portions 112, 113, 136; display area 114; portable devices 116, 116′, 116″; content 120, 124, 130, 226; communication links 132, 148, 150; cursor 142; items 144; controls 146; apparatus 200; processor 252; storage device 254; transceiver 256; information 260; and instructions 262 may all be characterized as “modules” herein.

Such modules may include hardware circuitry, single and/or multi-processor circuits, memory circuits, software program modules and objects, and/or firmware, and combinations thereof, as desired by the architect of the apparatus 200, and as appropriate for particular implementations of various embodiments. For example, such modules may be included in an operation simulation package, such as a software electrical signal simulation package, a message propagation simulation package, a network host simulation package, a network advertising simulation package, and/or a combination of software and hardware used to operate, or simulate the operation of various potential embodiments.

It should also be understood that the apparatus and systems of various embodiments can be used in applications other than hosts coupled via networks, and thus, various embodiments are not to be so limited. The illustration of an apparatus 200 is intended to provide a general understanding of the structure of various embodiments, and not to serve as a complete description of all the elements and features of apparatus and systems that might make use of the structures described herein. Such apparatus and systems may further be included as sub-components within a variety of electronic systems and processes, including local area networks (LANs) and wide area networks (WANs), among others.

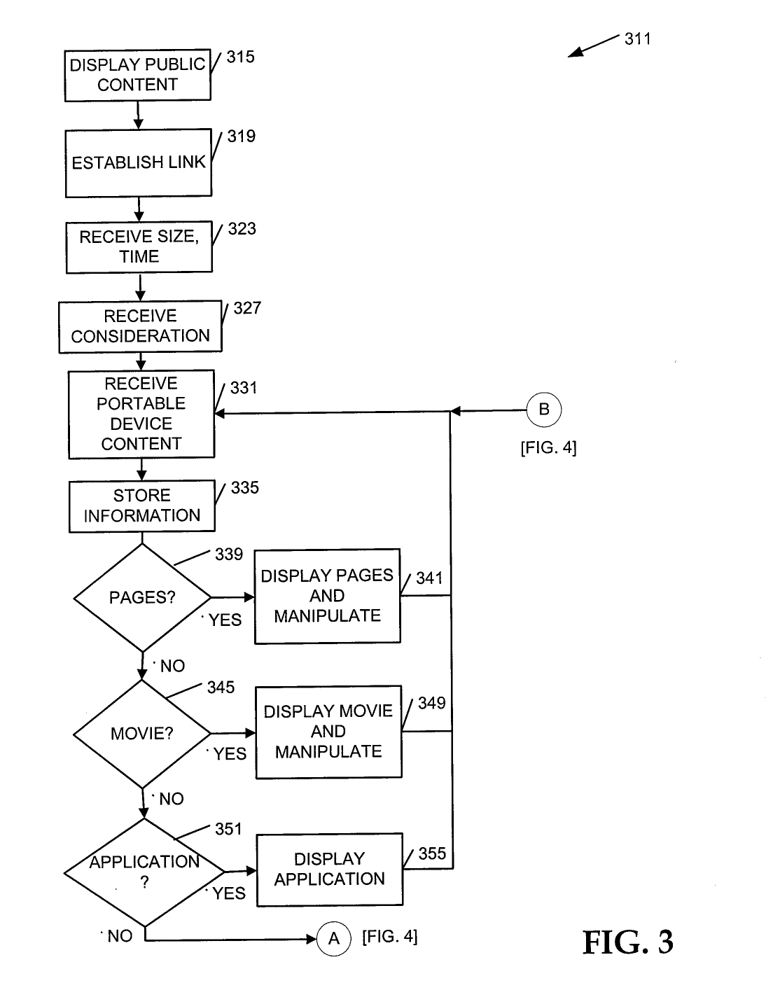

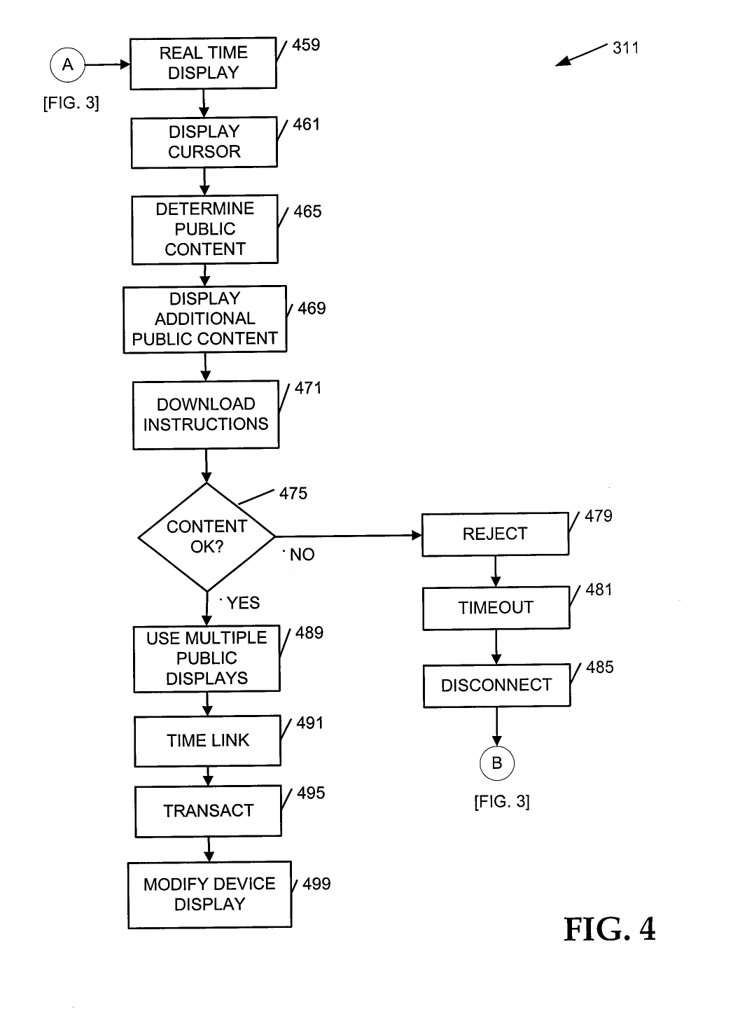

Some embodiments may include a number of methods. FIGS. 3 and 4 include flow diagrams illustrating several methods according to various embodiments of the invention. A computer-implemented method 311 to extend the display of portable devices may (optionally) begin at block 315 with displaying public content (e.g., advertising information, public service information, or warnings, etc.) on a public display. The public content may be received via a wired or wireless link, such as a wide area wireless link. The method 311 may go on to include at block 319 establishing a temporary short range wireless link between at least one portable device and a public display having public content displayed on a first portion of the public display. This may include receiving, at the public display, a request from one or more portable devices to extend a user display of the portable device(s) to a second portion 112 of the public display. Referring back to FIG. 2, it can be seen that in some cases, the first portion of the public display 110 may include the entire display area 114, except for the part of the display area 114 occupied by the second portion 112.

Referring now to FIG. 3, it can be seen that in some embodiments, the method 311 may include, at block 323, selecting a size of the display and/or the time (duration) of display associated with the second portion of the public display after establishing the short range wireless link, or as part of establishing the short range wireless link, perhaps in response to commands received from the portable device at the public display. In this way, the user of the portable device may have some effect on the size/time of extending the presentation of portable device content to the second portion of the public display.

The method 311 may include, at block 327, receiving monetary consideration in return for displaying the portable device content. For example, the user of the portable device can pay the public display owner based on the time the display is extended, or the size of the extended display, or both. Payment may be received prior to, after, or during the period of usage by the portable device.

In some embodiments, receiving monetary consideration at block 327 includes receiving consideration for one or more advertisements presented as part of the public content that has been updated based on a selection made by the user of the portable device. Monetary consideration may also be received for an advertisement presented as part of the public content on the public display, wherein the advertisement corresponds at least in part to characteristics of the portable device content currently displayed, or a history of the portable device content (collectively, these are “aspects” of portable device content), as noted previously. Monetary consideration for advertising may be paid by parties with an interest in having their advertisements viewed. In most embodiments, the method 311 includes, at block 331, receiving portable device content from the portable device over the short range wireless link at the public display. For example, the activity at block 331 may include forwarding the portable device content using the short range wireless link after the portable device content is received at the portable device via a wide area wireless link.

The method 311 may go on to block 335 to include storing information (e.g., characteristics) associated with the portable device content to include the type of portable device content. For example, the type of content might be the genre or topic of displayed text, the file name of a desktop object to be manipulated, etc. The type of content might by sorted to classify material that portable device users choose to display on the public display, and this information might be reported to the owner of public display. Once the information is stored, the activities at block 335 may include searching a history of the portable device content (created by storing the information) to identify content characteristics (e.g., Internet home page of portable device content, key words or images present in the content, themes included in the content, etc.). The currently-displayed public content may then be modified and/or selected to include advertising content associated with the characteristics.

The method 311 may go on to include displaying the portable device content as Internet content and/or paginated content on the public display at block 341, if it is determined that the portable device content is formatted according to pages at block 339. The paginated content may comprise text and/or graphics. The method 311 may then include one or more of selecting Internet content links, or turning, scrolling, zooming, panning, or tilting the pages responsive to commands received from the portable device. This adds the ability for portable device users to surf the Internet, or to read a book or magazine on the second portion of the public display.

The method 311 may go on to include displaying the portable device content as a movie on the public display at block 349, if it is determined that the portable device content is formatted as a series of images comprising a moving picture at block 345. The method 311 may then include playing or pausing the movie responsive to commands received from the portable device. This adds the ability for portable device users to watch a movie on the second portion of the public display.

The method 311 may go on to include displaying the portable device content as displaying the portable device content as portable device application activity on the public display, including the display of a computer desktop and individual applications, such as word processing, spreadsheets, etc. on the public display at block 355, if it is determined that the portable device content is formatted as a portable device application at block 351. The method 311 may then include manipulating objects on the computer desktop responsive to commands received from the device. This adds the ability for portable device users to read email, file documents, access corporate portals, etc. on the second portion of the public display.

Turning now to FIG. 4, it can be seen that the method 311 includes providing a display area for the portable device in a second portion of the public display and displaying, to a user of the portable device, at least some of the portable device content on the second portion of the public display in substantially real time at block 459. The activities at block 459 may include receiving control signals from the portable device at the public display to control the display of the portable device content in the second portion of the public display.

In some embodiments, the method 311 may include, at block 461, displaying a cursor on the public display. The location of the cursor and the selection of items on the public display can be controlled by user commands received from the portable device via manipulation of controls on the portable device. The selection of an item on the public display may result in new or revised public content being displayed. Alternatively, the selection of an item on the public display may result in new content being displayed at least temporarily within the second portion of the public display. This new content is provided by the public display processor for a time or until a command is received from the portable device after which the second portion, or portable device window of the public display may return to displaying content controlled by the portable device.

The method 311 may include determining the public content at block 465. This public content, displayed on the public content area of the public display, can be determined in a number of ways—many of them automated. For example, the method 311 may include determining at least a portion of the public content based on information included in the portable device content. That is, some portion of advertising on the public display may be queued up based on the portable device content characteristics (e.g. keywords/phrases found in the portable device content extended to the public display). In some embodiments, the method 311 may include updating a portion of the public content based on a selection of an item shown as part of the public content and made by a cursor under control of the portable device. The public content may also be selected based on the current geo-location of the public display, the time of day, and/or the history of previously-received portable device content, among others. The geo-location for example may allow advertising to reflect the nearby location of a product for sale.

In some embodiments, the method 311 may include receiving (using a wired or wireless connection) additional public content at the public display, and displaying the additional public content on the first portion of the public display at block 469. In this way, the public content may be updated on a periodic basis.

In some embodiments, the method 311 may include downloading executable instructions, such as programs, or information content to the portable device from the public display at block 471. Such instructions may include applets to present information to the portable device user at a later time, including advertising presented on the portable device itself, for example. An agreement to view downloaded advertising might serve as the consideration received from a portable device user that desires to make use of the extension of portable device content to a public display in some embodiments.

The portable device content that is extended to the public display may be monitored. Thus, the method 311 may include monitoring information included in the portable device content, at block 475, and if it is determined that the portable device content is not acceptable, the method 311 may go on to include rejecting display of the portable device content based on the information type at block 479. For example, the extended display of portable device content may be controlled according to one or more community standards, e.g. hate speech, violence, pornography, etc. Other standards might include whether the portable device content is deemed to be destructive (e.g., a computer virus or some other form of malware).

If the portable device content is rejected, the method 311 may include selecting a time period to prevent further display of portable device content provided by the portable device for the selected time period at block 481. In this way, the public display may operate to reject, for a time-out period, the reception of further portable device content from a portable device based on the prior reception of unacceptable content at the public display. The method 311 may also include disconnecting the public display from the short range wireless communication link with the portable device when unacceptable content is received from the portable device at block 485.

If the portable device content is determined to be acceptable at block 475, the method 311 may go on to include, at block 489, displaying multiple portions of the portable device content across multiple public displays, perhaps responsive to receiving a request from the portable device at a single public display, or responsive to establishing multiple short range wireless links between the portable device and multiple public displays. In this way, a single portable device can communicate with multiple public displays simultaneously. The portable device content may, or may not be collectively coherent. In other words, the portable device content spread across multiple public displays may form one cohesive single display, or multiple, independent displays. If the portable device content is collectively coherent, the multiple portions can represent subsets of a larger virtual image included in the portable device content, and the multiple portions can be displayed across multiple public displays in a spatial relationship corresponding to the relative location of the subsets within the larger virtual image.

The method 311 may go on to include, at block 491, permitting the short range wireless link to remain established for a time period based on the type of portable content (assuming the acceptability of the portable content type has already been examined at block 475). In this way, the owner of the public display can stay apprised of recent trends in requests for extension of portable device displays, and reward portable device users that select specific acceptable portable content for extended viewing with additional viewing time.

In some embodiments, the method 311 includes, at block 495, interactively completing a commercial transaction displayed on the public display responsive to commands received from the portable device, so that items can be purchased, or other transactions accomplished, using the link between the portable device and the public display.

The method 311 may include, at block 499, transmitting information from the public display to be used in modifying the user display of the portable device responsive to content selections received from the device and associated with the public content. That is, if the portable device is operated to select items displayed on the public display (perhaps using a cursor on the public display), the public display may in turn transmit information to the portable device that operates to modify the display of the portable device. In this way, a “mouse click” using a portable device-controlled cursor displayed on the public display public content area, for example, can result in the delivery of related information to the portable device for display on that device.

Those of ordinary skill in the art will realize that the various activities described with respect to the operations of the devices and methods illustrated in FIGS. 1-3 can be combined in many ways. For example, in some embodiments, a computer-implemented method might comprise displaying public content on a first portion of a computer controlled public display, establishing a temporary short range wireless link between the public display and at least one portable device, and displaying a cursor on the public display, wherein the location of the cursor on the public display and selection of items displayed by the public display is controlled by user commands received from the portable device. The method might further comprise updating a portion of the public content based on the selection, receiving, at the public display, monetary credentials provided by the portable device, and completing a monetary based transaction at the public display. Here, monetary credentials might be provided by the portable device via transmitting a credit card number, a social security number, a personal identification number, etc. from the portable device to the public display over the short range wireless link, perhaps as part of a burst transmission, where all of the monetary credentials are sent to the public display in a single message. Other methods may also be realized using various combinations of the illustrated devices and activities.

It should be noted that the methods described herein do not have to be executed in the order described, or in any particular order. Thus, various activities described with respect to the methods identified herein can be executed in repetitive, simultaneous, serial, or parallel fashion. Information, including parameters, commands, operands, and other data, can be sent and received in the form of one or more wireless modulation methods.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment, including hypertext markup language (HTML) and extensible markup language (XML).

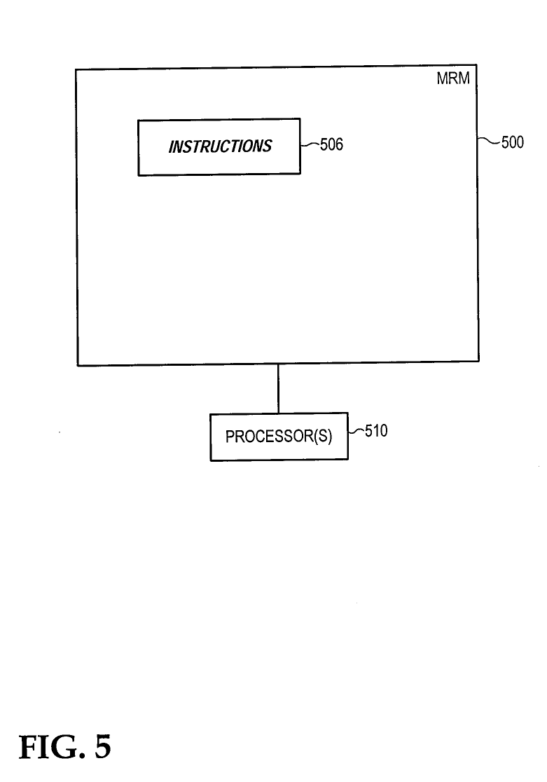

Thus, other embodiments may be realized. For example, FIG. 5 is a block diagram of an apparatus including a machine-readable medium (MRM) 500 according to various embodiments of the invention. Examples of such embodiments may comprise a memory system, a memory circuit, a magnetic or optical disk, a flash drive, or some other storage device. The MRM 500 may contain instructions 506 which, when accessed, result in one or more processors 510 performing any of the activities previously described, including those discussed with respect to the methods 311 noted above. For example, the MRM 500 may comprise firmware used to simulate the operations described above, or to direct the execution of such operations in association with one or more hosts in a networked data processing and communications environment. The MRM 500, processors 510, and instructions 506 may be similar to or identical to the storage device 254, processor 252, and instructions 262 of FIG. 2, respectively.

Thus, in some embodiments, a MRM 500 may have instructions 506 stored thereon which, when executed by a computer (e.g., one or more processors(s) 510), cause the computer to perform operations such as establishing a temporary short range wireless link between at least one portable device and a computer controlled public display having public content displayed on a first portion of the public display, providing a display area for the portable device in a second portion of the public display, receiving portable device content from the portable device over the short range wireless link at the public display, and displaying, to a user of the portable device, at least some of the portable device content on the second portion of the public display in substantially real time.

Additional operations may include examining the type of portable device content, storing information associated with the portable device content to include the portable device content type (e.g., genre, etc.), and permitting the short range wireless link to remain established for a time period based on the portable device content type. Other operations may include searching a history of the portable device content to identify content characteristics, and displaying modified public content that includes advertising content associated with the characteristics. In some embodiments, additional operations may include determining a portion of the public content based on at least one of the geo-location of the public display, the portable device content, or a selection received from the portable device of an item displayed on the public display.

Implementing the apparatus, systems, and methods according to various embodiments may permit extending the display of portable device content onto public displays such that an additional source of revenue may be provided to the public display owners. This mechanism can serve the dual-function of increasing portable device display capability, as well as increasing the ability of public display owners to display advertising that is more closely targeted to the local viewing audience.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method, comprising:
displaying public content on a first portion of a computer controlled public display;
establishing a temporary short range wireless link between the public display and at least one portable device;
providing a display area for the portable device in a second portion of the public display;
receiving portable device content from the portable device over the short range wireless link at the public display; and
receiving control signals from the portable device at the public display to control the display of the portable device content in the second portion of the public display.

2. The method of claim 1, comprising:
displaying a cursor on the public display, wherein a location of the cursor on the public display and selection of items displayed by the public display is controlled by user commands received from the portable device.

3. The method of claim 2, comprising:
updating a portion of the public content based on the selection.

4. The method of claim 1, comprising:
receiving monetary consideration for an advertisement related to an aspect of the portable device content presented as part of the portion of the public content.

5. The method of claim 1, comprising:
displaying the portable device content as Internet content on the second portion of the public display; and
selecting Internet content links forming a part of the Internet content responsive to commands received from the portable device.

6. The method of claim 1, comprising:
displaying the portable device content as pages on the second portion of the public display; and
at least one of turning, scrolling, zooming, panning, or tilting the pages.

7. The method of claim 1, comprising:
displaying the portable device content as portable device application activity on the public display.

8. The method of claim 1, comprising:
receiving a modification to the public content at the public display; and
displaying modified public content on the first portion of the public display.

9. The method of claim 1, comprising:
monitoring information included in the portable device content;
rejecting display of the portable device content based on a type of the information; and
responsive to the rejecting, preventing further display of the portable device content provided by the portable device for at least a time period.

10. The method of claim 1, comprising:
receiving monetary consideration in return for displaying the at least some of the portable device content.

11. The method of claim 1, comprising:
receiving monetary consideration for an advertisement presented as part of the public content on the public display, wherein the advertisement corresponds at least in part to a history of the portable device content.

12. The method of claim 1, comprising:
receiving additional advertising revenue based on offering an option to display the portable device content.

13. The method of claim 1, comprising:
selecting at least one of a size of display or a time of display associated with the second portion after establishing the short range wireless link and responsive to commands received from the portable device at the public display.

14. The method of claim 1, comprising:
displaying multiple portions of the portable device content across multiple public displays responsive to establishing multiple short range wireless links between the portable device and the multiple public displays.

15. The method of claim 14, wherein the multiple portions represent subsets of a larger virtual image included in the portable device content, comprising:
displaying the multiple portions across the multiple public displays in a spatial relationship corresponding to a relative location of the subsets within the larger virtual image.

16. The method of claim 1, comprising:
forwarding the portable device content using the short range wireless link after the portable device content is received at the portable device via a wide area wireless link.

17. An apparatus, comprising:
a public display to display a combination of public content selected by logic in the public display, and portable device content provided by one or more portable devices; and
a wireless transceiver to establish a temporary short range wireless link with the one or more portable devices to extend the display of the portable device content to a portion of the public display, wherein the public display is to display some of the portable device content on the portion of the public display, and wherein the display of the portable device content is controlled in part by communication received at the public display over the short range wireless link.

18. The apparatus of claim 17, comprising:
a storage device to couple to the wireless transceiver and to record advertising information associated with the portable device content.

19. The apparatus of claim 17, comprising:
a processor to couple to the transceiver, wherein the processor is to execute instructions to determine a portion of the public content based on at least one of a geo-location of the public display, the portable device content, or a selection received from the portable device of an item displayed on the public display.

20. A machine-readable medium comprising instructions which, when executed by one or more processors, cause the one or more processors to perform the following operations:
establish a temporary short range wireless link between at least one portable device and a computer controlled public display;
display public content on a first portion of the public display;
provide a display area for the portable device in a second portion of the public display;
receive portable device content from the portable device over the short range wireless link at the public display; and
display, to a user of the portable device, at least some of the portable device content on the second portion of the public display under at least partial control of the portable device.

21. The machine-readable medium of claim 20, wherein the instructions, when executed by the one or more processors, cause the one or more processors to perform the following operations:
search a history of the portable device content to identify content characteristics; and
modify the public content to include advertising content associated with the characteristics.

22. The machine-readable medium of claim 20, wherein the instructions, when executed by the one or more processors, cause the one or more processors to perform the following operations:
examine a type of the portable device content; and
permit the short range wireless link to remain established for a time period based on the type.

23. The machine-readable medium of claim 20, wherein the instructions, when executed by the one or more processors, cause the one or more processors to perform the following operations:
determine a portion of the public content based on at least one of a geo-location of the public display, the portable device content, or a selection received from the portable device of an item displayed on the public display.

24. A computer-implemented method, comprising:
displaying public content on a first portion of a computer controlled public display;
establishing a temporary short range wireless link between the public display and at least one portable device;
displaying a cursor on the public display capable of pointing at items within the public content, wherein a location of the cursor on the public display and selection of the items within the public content is controlled by user commands received from the portable device;
updating a portion of the public content based on the selection;
receiving, at the public display, monetary credentials provided by the portable device; and
completing a monetary based transaction at the public display.
